(19) United States
(12) Patent Application Publication
(10) Pub. No.: US 2014/0292753 A1
(43) Pub. Date: Oct. 2, 2014

(54) METHOD OF OBJECT CUSTOMIZATION BY HIGH-SPEED AND REALISTIC 3D RENDERING THROUGH WEB PAGES

(71) Applicant: Sheng BI, Zhuhai (CN)

(72) Inventor: Sheng BI, Zhuhai (CN)

(21) Appl. No.: 14/221,042

(22) Filed: Mar. 20, 2014

(30) Foreign Application Priority Data
Apr. 2, 2013 (CN) 201310113082.6

(51) Int. Cl. G06T 15/00

(52) U.S. Cl. CPC G06T 15/00
USPC 345/420

(57) ABSTRACT

A method of object customization by high-speed and realistic 3D rendering through web pages, including generating a 3D model of an object with a three dimensional modeling tool; outputting the 3D model to a 3D model file; loading the 3D model file into the system 400; preprocessing the 3D model file; and generating a binary snapshot file of the 3D model file. The method further includes loading the binary snapshot file; color-separated rendering of various parts of the 3D model of the object; and saving the data of the color-separated rendering in mask images. The method additionally includes calculating object portion specifications and object portion extensibility based on user selection of targeted areas of the 3D model image; displaying the subsequent targeted portions of the 3D model after recalculation; and displaying the resulting images of the 3D model of the object after combining the calculated portions with the 3D model, without rerendering the 3D model.

### CROSS-REFERENCE TO RELATED APPLICATIONS

The present application claims priority benefit under 35 U.S.C. §119(a) Chinese Application No. CN 201310113082.6, entitled “Method of Object Customization by High-Speed and Realistic 3D Rendering Through Web Pages,” filed Apr. 2, 2013, the contents of which are incorporated herein by reference in their entirety.

### FIELD OF THE INVENTION

The present invention relates to three dimensional (“3D”) rendering of images, and in particular, to a method of object customization by high-speed and realistic 3D rendering through web pages.

### BACKGROUND OF THE INVENTION

In traditional electronic business, goods are purchased or designed independently, bulk produced, and sold to customers through an Internet or Web platform. With the improvement of living standards, user demands for personalized customization of goods are increasing. These demands are difficult to satisfy through traditional lines, but the development of the electric business can make meeting these demands possible.

At present, in the electronic business practice on the Internet, there are already many kinds of online customized solutions of goods, allowing the customers to customize the portions of various parts of the goods. Online resources provide the function of 3D displaying, and the customers can see the final image of the goods from different angles prior to receiving the goods. However, while customizing the portions of various parts of the goods, it is necessary to assign the portions of various parts at the time of creating a 3D model. That is to say, it is necessary to realize the replacement of the portions in a 3D modeling tool, so as to ensure the proportions and angles between the portions and the 3D model satisfy the requirements of rendering to achieve realistic display of the goods. Thus it is necessary to modify the model or create a new model of the goods with a 3D modeling tool in case of replacing or modifying any of the portions of the goods and to achieve subsequent realistic displaying of the model, such that the time for replacing the portions and realistic displaying to users is lengthy.

In addition, in the existing online customized solutions of goods concerning 3D rendering, the original 3D model file comprises all the spatial geometric data. It is necessary to analyze and reconstruct this data each time a rendering is made or the object is displayed in a traditional rendering method, resulting in low efficiency. Normally, it takes several minutes to perform the rendering with one engine, which is an excessive time for an online transaction. Thus, the demand for real-time performance for customization and display cannot be satisfied at all.

The reason for the low efficiency of the 3D rendering in these solutions is that the 3D model utilizes object format (“OBJ”) files that have high versatility to conveniently exchange with other systems. A feature of this format is saving three dimensional data in text mode, with an advantage of high versatility, but with a disadvantage of low processing speed. The size of a high-precision OBJ file of a three dimensional model having a million triangles is generally about 150 megabytes (“M”). Loading and processing these text files consumes large amounts of CPU processing and input/output (“I/O”) time. According to estimates, it needs more than 10 seconds to read and load a 150M OBJ file. Clearly, the requirements of online customizations cannot be satisfied with such a rendering system.

The information disclosed in this Background of the Invention section is only for the enhancement of understanding of the general background of the invention and should not be taken as an acknowledgement or any form of suggestion that this information forms the prior art already known to a person of ordinary skill in the art.

### SUMMARY OF THE INVENTION

In consideration of the above drawbacks in the prior art, the present invention provides a method of object customization by high-speed and realistic 3D rendering through web pages.

According to certain embodiments, a method is provided for object customization by high-speed and realistic 3D rendering through web pages, including generating a 3D model of an object with a three dimensional modeling tool; outputting the 3D model to a 3D model file; loading the 3D model file into the system; preprocessing the 3D model file; and generating a binary snapshot file of the 3D model file. When rendering of the 3D model is triggered, the method further includes loading the binary snapshot file; color-separated rendering, by a 3D rendering engine, of various parts of the 3D model of the object; and saving the data of color-separated rendering in mask images. The method additionally includes calculating object portion specifications and object portion extensibility based on user selection and customization of one or more targeted portions of an image of the 3D model of the model; displaying the one or more targeted portions of the 3D model based on the calculated object portion specifications and object portion extensibility; and displaying the resulting image of the 3D model of the object after combining the calculated portions with the 3D model, without rerendering the 3D model.

Certain embodiments provide for a method for object customization by high-speed and realistic 3D rendering through web pages as above, wherein generating the binary snapshot file includes applying for a memory space with the same size as the 3D model file, analyzing three dimensional data in the 3D model file, and generating data in binary format that can be used for rendering directly by the 3D rendering engine, as well as recopying the data in binary format into the space successively according to a preset sequence and modifying offset distances of pointers accordingly.

Additional embodiments are directed to a method for object customization by high-speed and realistic 3D rendering through web pages as above, wherein the binary snapshot file is in the form of a binary stream compressed in Lempel-Ziv-Oberhumer (“LZO”) format.

Particular embodiments further provide for a method for object customization by high-speed and realistic 3D rendering through web pages as above, wherein the 3D model file is in OBJ format.

Further embodiments provide for a method for object customization by high-speed and realistic 3D rendering through web pages as above, wherein the data format used in the OBJ format file is 16-bit unsigned integers.

Embodiments also provide for a method for object customization by high-speed and realistic 3D rendering through web pages as above, wherein the 3D rendering can be triggered through web pages.

Embodiments additionally include a method for object customization by high-speed and realistic 3D rendering through web pages as above, wherein the three dimensional modeling tool includes 3DMAX or MAYA.

Embodiments include a method for object customization by high-speed and realistic 3D rendering through web pages as above, wherein displaying the resulting images of the 3D model of the object after rendering or combining is performed through JavaScript technology.

Certain embodiments also provide for a method for object customization by high-speed and realistic 3D rendering through web pages as above, wherein the resulting images are pictures of the 3D model of the object from different angles.

Additional embodiments include a method for object customization by high-speed and realistic 3D rendering through web pages as above, wherein while accessing the pages, displaying several pictures of the object successively through rotation of a mouse wheel to achieve the perspective of three dimensional displaying of the object.

In certain embodiments, there is provided a method for object customization by high-speed and realistic 3D rendering through web pages of the present invention, generating the binary snapshot file of the 3D model file by preprocessing the 3D model file loaded into the system, so that it is not necessary to reanalyze or reload the 3D model file again while doing another rendering, unless the 3D model is modified, so that the rendering time is reduced to 2 seconds. Furthermore, calculating only the object portion specifications and object portion extensibility based on targeted portions of an image of a 3D model of the object selected by a user, and displaying the targeted portions of the 3D model based on the calculated object portion specifications and object portion extensibility, permits a user replacing the targeted portions of the 3D model by merely selecting the targeted portions of the object. The system according to the present invention can achieve displaying the targeted and customized portions in various parts of the goods realistically without modifying the 3D model or creating a new 3D model, resulting in reducing a lot of work, reducing the burden of the system, and saving the time of users at the same time.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The present invention has other features and advantages which will be apparent from or are set forth in more detail in the accompanying drawings, which are incorporated herein, and the following Detailed Description, which together serve to explain certain principles of the present invention and to enable a person of ordinary skill in the art to make and use the embodiments disclosed herein. In the drawings, like reference numbers indicate identical or functionally similar elements.

FIG. 1 is a flowchart illustrating the steps for object customization and display by high-speed and realistic 3D rendering through web pages in accordance with exemplary embodiments of the present invention.

FIG. 2a, FIG. 2b, FIG. 2c, FIG. 2d, FIG. 2e, FIG. 2f, and FIG. 2g are exemplary mask images of color-separated rendering of an object, showing the portions of an exemplary object shoe according to exemplary embodiments of the present invention.

FIG. 3a, FIG. 3b, and FIG. 3c are images of rendering objects using the method of the present invention.

FIG. 4 illustrates the architecture of a network for implementing a method of object customization and display by high-speed and realistic 3D rendering through web pages.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes can be determined in part by persons of ordinary skill in the art for the particular intended application and use environments.

### DETAILED DESCRIPTION OF THE INVENTION

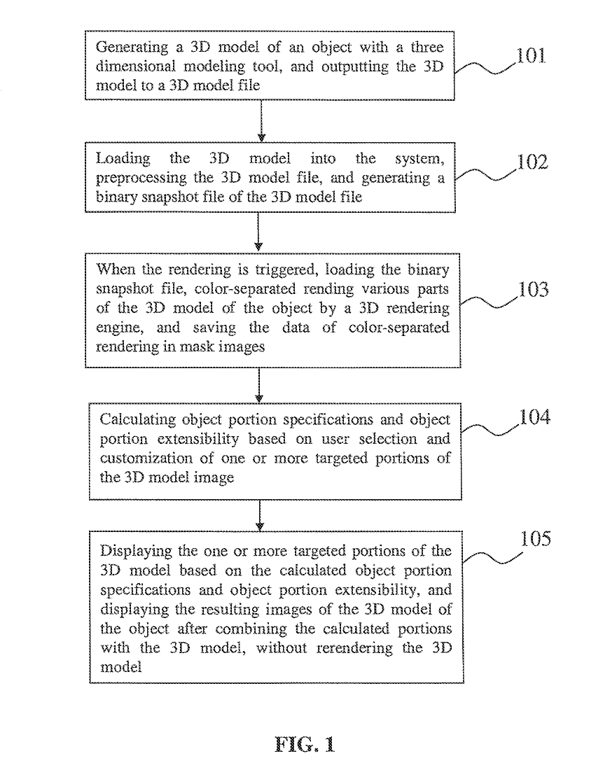

Although the described embodiments can be implemented in any appropriate type of network system supporting any suitable communication standards and using any suitable components, particular embodiments can be implemented in a network such as shown in FIG. 1.

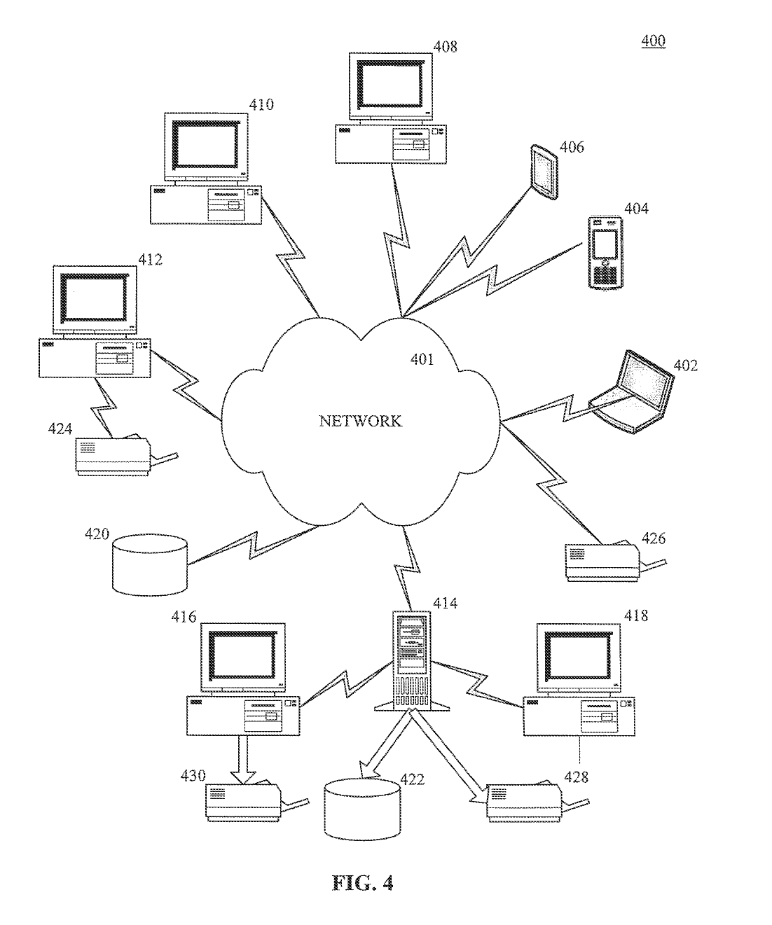

Referring first to FIG. 4, there is shown an architecture of a network and system 400 for implementing a method for object customization by high-speed and realistic 3D rendering through web pages. The network 401 across which communication in exemplary embodiments occur, can include any private or public, wired or wireless network, including but not limited to Local Area Networks, Wide Area Networks, the Internet, the World Wide Web, and a Cloud-based network. There is shown an exemplary network server 414 and one or more databases and/or storage devices 420 and 422. There may be one or more servers 414 and one or more databases 420 and 422, with the servers minimally configured with memory and at least one processor, and with the databases being external to or integrated with the servers 414. There are one or more user devices 402-412, 416, and 418 (collectively referred to as user device 410) for utilizing the object customization system 400 to access, customize, and display/view objects and 3D model images of objects and goods. The user can effect the rendering, or the calculation of altered images of changed objects and goods, through web pages by accessing the disclosed method through a user device 410, inputting commands, instructions, and/or selections, trigger the rendering of an altered image and be able to view the altered image on the user device 410. The actual rendering can be performed on the server 414, the user's device 410 or on another device (not shown) connected through the network 401, with the rendering results being transmitted to the user's device 410 from a non-user device.

User device 410 for permitting user interface with the real time object customization system 400 are representatively shown as a portable tablet 406, a portable laptop computer 402, a cell phone 404, and a desktop computer 408. Examples of user devices 410 include, but are not limited to, wireless user equipment and communication devices, such as, for example, mobile telephones, personal digital assistants, electronic readers, portable electronic tablets, personal computers, and laptop computers. Each user device 410 minimally comprises a processor, a memory coupled to the processor, a display coupled to the processor, and an antenna or other wired or wireless connection device coupled to the processor for receiving and transmitting information, messages, and/or commands or instructions. The display includes touch screen technology for the entry of user reactions and information, whether in text form or by touching action buttons displayed on the screen of the user device 410. Alternately, user entry of information and reactions can be through use of a physical or touch screen keyboard.

An exemplary authentication server 414 can be utilized to verify the identity of the user when prior authorization is required for the user to use the system 400 for the entry of the user's selections for customization and display of an object. One or more printers or other output devices 424-430 are available to provide output copies and images, including original 3D models of objects, targeted portions of objects, and 3D models of customized objects and goods.

Exemplary embodiments are implemented on the computers of the object customization system 400, including the user device(s) 410, server(s) 414, storage devices 420 and 422, and output devices 424-430. Each of the computers 402-418 have one or more processors for the processing of software instructions; for receiving, analyzing, and processing user selections; for calculating object portion specifications and object portion extensibility; for displaying 3D model images and object portion images; and for combining calculated object portions with a 3D model for displaying the resultant customized 3D model. Processing, generating, loading, rendering, calculating, displaying, and combining functions can be implemented in a number of electronic devices within embodiments covered by the present concepts. For example and not limitation, one or more of the exemplary computers can comprise cellular telephones, including smart phones, and/or personal digital assistants, including tablet devices; and the computer users can communicate through the computers using known electronic user interfaces.

Computer-executable instructions, or software, are provided for directing the processing of the computers 402-418, including processing the steps of exemplary embodiments of the object customization 400. The computer-executable instructions, when executed by the computers 402-418 and/or the processors associated with each of said computers, provide for the presentation of images and selection options to the user device 410; receiving selections and information back from the user device 410 related to the user selections and customizations of an object and/or the targeted portions of an object; displaying and calculating the specifications and extensibility of the targeted portions of the object; combining the calculated portions of the targeted portions with the 3D model to generate a display of the customized 3D model. One or more storage devices 420 and 422 are provided for storage of images, pictures, targeted portions, model files, and binary snapshots of model files utilized in the object customization 400. The software can be stored on the storage devices 420 and/or 422, can be loaded into the memory of the computers 402-418, or can be stored onto separate storage means within the computers 402-418. Further, the software can comprise separate programs and sets of instructions or can be combined into a single program, set of instructions, or program module(s).

Computer readable program code may be stored in a computer readable medium, such as, but not limited, to magnetic media (e.g., a hard disk), non-transitory memory, optical media (e.g., a DVD), memory devices (e.g., random access memory), and the like. In some embodiments, computer readable program code is configured such that, when executed by a processor, the code causes the exemplary computers 402-418 to perform steps described below (e.g., steps described below with reference to the flow chart shown in FIG. 1). In other embodiments, the exemplary computers 402-418 configured to perform steps described below without the need for code. Therefore, the features of the present embodiments described herein may be implemented in any suitable combination of hardware and/or software.

Referring now to FIG. 1, there is shown a flowchart of a method for object customization and display by high-speed and realistic 3D rendering through web pages in accordance with exemplary embodiments of the present invention. The present invention provides a method for object customization by high-speed and realistic 3D rendering through web pages, wherein users select various parts or portions of an object stored in a server through web pages to customize the object. Hereinafter, the steps of this method will be described in detail.

In step 101, a three dimensional model of the object is generated with a three dimensional modeling tool, and the resulting model is output or written to a 3D model file. The 3D model file comprises all the spatial geometric data of the modeled object. In an exemplary embodiment, the 3D model utilizes the OBJ format because of its high versatility. While other formats can be utilized, the following discussions will presume use of the OBJ format, The 3D model file of this format comprises three dimensional geometric data of the model, and the geometric data can comprise tens of thousands to millions of triangles made up of points and lines. Preferably, the three dimensional modeling tool is 3DMAX or MAYA software; although other modeling software can be used without detracting from the exemplary embodiments of the invention.

The length field in the existing OBJ-formated model file takes the format of a 32-bit unsigned integer, expressing a length range from 0 to 2³²−1, which is sufficient to describe an object with the length of a side of forty thousand (40,000) kilometers. However, for the requirements of most online customizations of goods, the largest object needing to be described, customized, and displayed is, for example, a piece of furniture. Therefore, the length field and corresponding file size is improved by the use of a smaller length field in the present invention. In an exemplary embodiment of the present invention, the length data are reduced to 16-bit unsigned integers. Consequently, the maximum length of the object that can be described is 65 meters, sufficient to satisfy most requirements for the online customizations of goods. This length field change reduces the size of disk model file by about 40%.

In step 102, the OBJ-format 3D model file is loaded into the customization system 400, the 3D model file is preprocessed in preparation for rendering, and a binary snapshot file of the 3D model file is generated.

In an exemplary embodiment, the process for generating the snapshot file includes the steps of applying for a memory space with the same size as the original OBJ 3D model file, analyzing the three dimensional data in the OBJ model file, and generating data in binary format (i.e., a “snapshot” of the object) that can be used for rendering. The analyzing step processes the point, line, and area information of the 3D model to convert the information to an internal format for storage. The generated data includes coordinates of positions and portions (i.e., the various parts) of the object as represented as a 3D model. The generated binary snapshot data can be used directly by the 3D rendering engine, as well as for recopying the data in binary format into the file space successively according to a preset sequence and modifying offset distances of pointers accordingly. The pointers to memory may need to be offset if the memory allocation changes for the output of the recopying. The present sequence can automatically be determined by the system to efficiently copy the data to a string of contiguous regions of the object. After the OBJ model file is loaded completely, and its data are analyzed, all the obtained binary data after loading are saved into a disk file; that is to say, the binary snapshot file is generated. This preprocessing of the object and resultant object image need be performed only one time, and there will be no further demand for 3D model files in the OBJ format for any subsequent rendering, unless for modifying the model itself. Thus, the speed of the overall rendering can be improved over previous methods.

To improve the speed of loading, the typical memory allocation mechanism provided in such systems is not utilized by the present invention. Instead, the invention utilizes its own memory management module. This module saves the binary data of the same model into a piece of memory successively. It is not necessary to further analyze the binary snapshot file while reading it, and the binary snapshot file can be read into assigned positions in memory or storage directly. It is not necessary to reanalyze the binary file in this process, and there is only a simple I/O operation, thereby obtaining additional improvements in performance.

Furthermore, in consideration that read/write performance of the disk I/O is two orders slower than memory I/O, the present invention further utilizes a LZO compression mechanism to save file space. That is to say, the binary snapshot file can be in the form of a binary stream compressed in LZO format. This further reduces the size of the file by more than 70%. By adopting this compression mechanism, the size of the OBJ-format file is reduced by more than 80%. For example, an originally-sized 150M OBJ file can be converted according to exemplary embodiments into a snapshot file, the size of which is about 20M. The loading performance of such exemplary files is also improved, from 10 seconds to within 1 second,

In step 103, when the rendering of the object image is triggered for display to the user, the 3D rendering engine loads the binary snapshot file, renders various parts or portions of the 3D model of the object, and saves the data of the rendering as mask images. The rendering can be color-separated rendering in which various parts, portions, and/or positions of the image are displayed in different (i.e., color-separated) colors for better visual separation. The mask images of the various parts or portions can be a projection drawing for the part or portion and can be created as a portable network graphics (png) or graphics interchange format (gif) file.

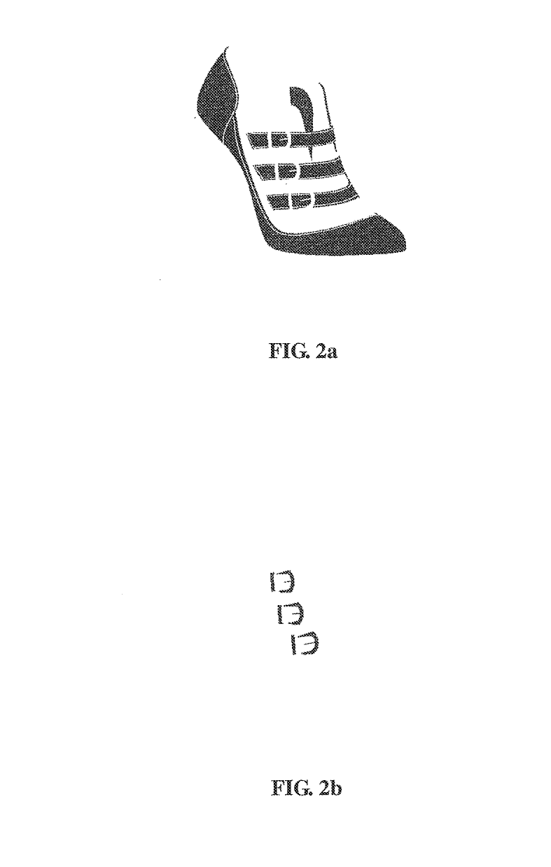

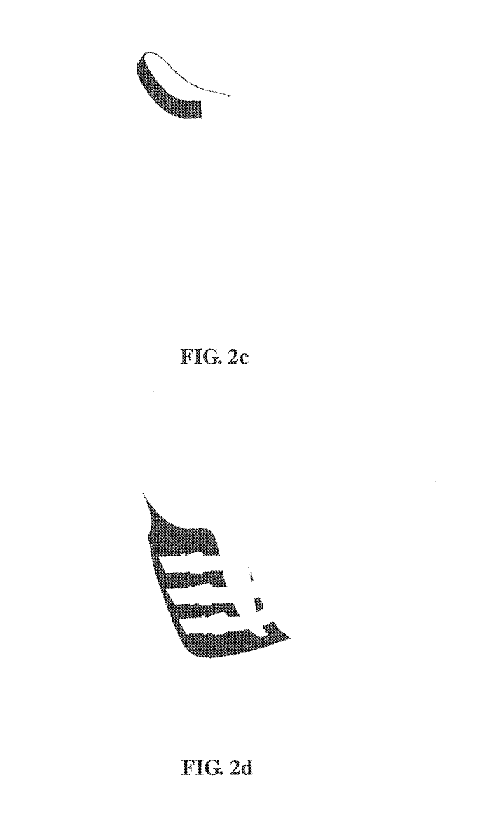

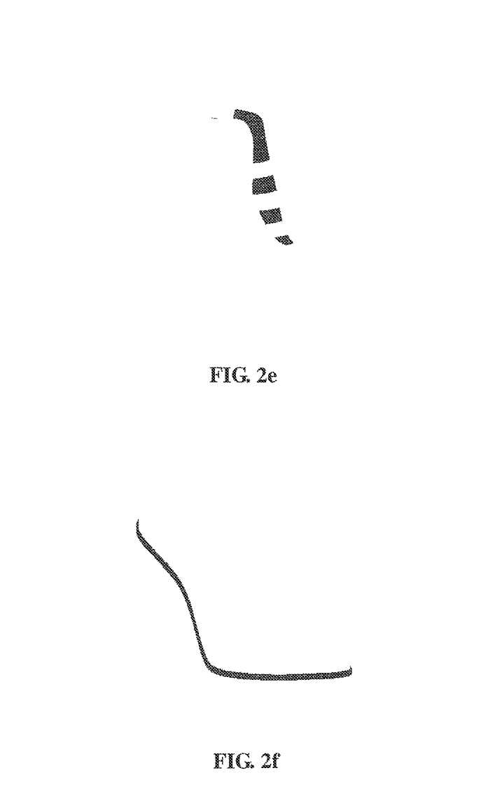

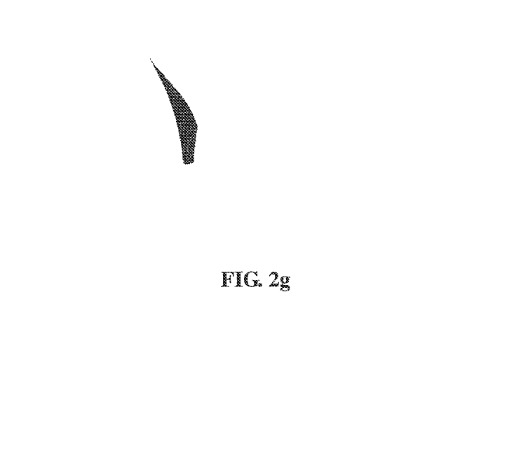

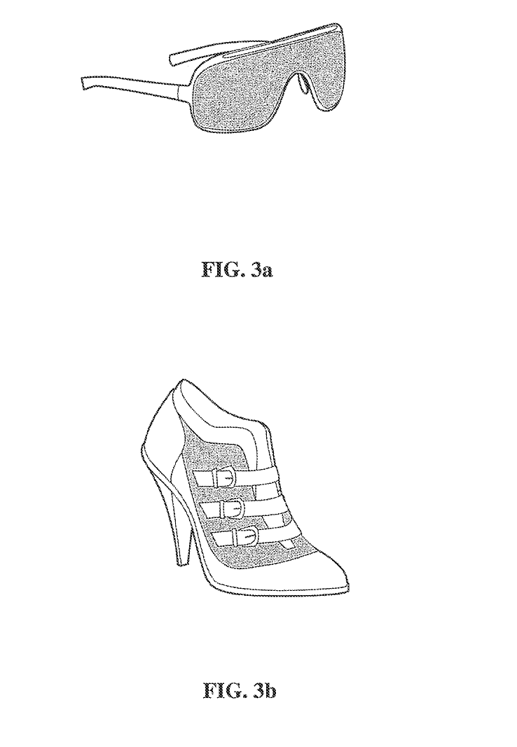

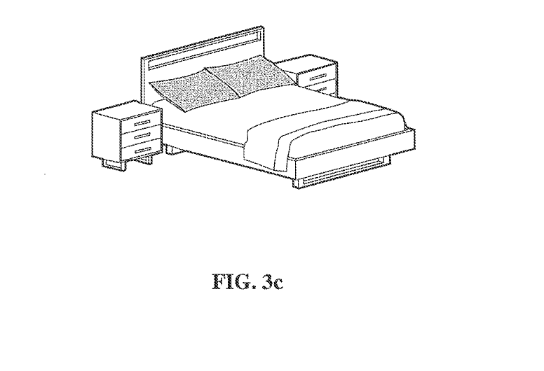

Color-separated rendering means imparting various parts or portions of the object as displayed with various colors. In particular, this step results in a particular targeted area or object portion being displayed as a particular color, and the other parts of the object displayed as a transparent color, thereby effectively becoming invisible in a display. FIG. 2a, FIG. 2b, FIG. 2c, FIG. 2d, FIG. 2e, FIG. 2f, and FIG. 2g are exemplary images of color-separated rendering of the object (such as a shoe) or object portions in mask images, with the figures showing the various parts of the shoe. These figures also show representative portions of the object (i.e., a shoe) that can be selected by the user for alteration and rerendering within the 3D model image (i.e., FIG. 3b).

In step 104, the user can calculate object portion specifications and object portion extensibility according to positions or portions of the targeted areas/object as selected by the user on the 3D model. The user can utilize a mouse or other comparable pointing device, including a touch screen, to select the desired portions or targeted areas by, for example, sliding the mouse over the image of the 3D model and clicking on the targeted portion of the 3D model of the representd object. Using the system 400 according to the method of the present invention, the coordinates of the particular position or portion selected by the user are automatically determined. The mask images corresponding to the coordinates (and thereby the selected position or portion) are determined, and the method overlays the 3D model image with the mask images, thereby displaying the targeted areas to users for selection and change. The user selects desired changes to the selected and displayed object portion, such as a different color, dimension, composition, style, orientation, etc. and triggers the recalculation of the object portion specifications and extensibility

In step 105, the altered image of the object is rendered on the web page being utilized by the user, and the resulting image of the 3D model of the object is displayed to the user, with the desired changes implemented into the targeted and selected portions or areas of the images according to portion specifications and portion extensibility. The rendering of the altered image of the object is accomplished by calculating only the selected and changes portions, thereby saving processing time for the rendering of the altered image to the user.

The 3D rendering can be triggered through web pages accessed by the user. The rendering engine can be adapted to color-separated rendering of the object. The rendering process is as followed: First, the front-end of the system 400 sends the rendering request to the rendering engine through a network 401. The rendering engine reads and loads the binary snapshot file needed to be rendered according to the rendering request. Meanwhile, picture files of the object portions required for rendering are also loaded. After the loading is completed, the engine sets a position for a camera first, and then analyzes the image of every point in the three dimensional model generated, and calculates object portion specifications and object portion extensibility according to the positions of targeted areas selected by users on the 3D model. Finally, a resulting customized image of the rendering is computed by combining the calculated portions with the 3D model and displayed. FIG. 3a, FIG. 3b, and FIG. 3c are exemplary resulting images of rendering several objects using the method of the present invention. The objects shown in FIG. 3a, FIG. 3b, and FIG. 3c include a pair of glasses, a shoe, and a bed as customized.

In the present exemplary embodiment, the resulting images of the customized model of the object can be displayed on web pages through JavaScript technology. These images represent many views of the model of the object from different angles. For example, eight images of an object or object portion from eight angles can be displayed successively through rotation of a mouse wheel while a user accesses the pages, to achieve the perspective of three dimensional displaying of the object or object portion.

In the present invention, after the 3D model file is loaded, the data in binary format are directly saved into an image file through continuous memory allocation technology. It is not necessary to reanalyze or reload the binary file; instead, it can be used directly. The intermediate data are saved in maximum limit in this format, avoiding the process of reconstructing the model in memory each time or utilizing large portions of memory, processing time, or storage.

Meanwhile, in the method of the present invention, calculating object portion specifications and object portion extensibility according to the positions of targeted areas selected by a user on the 3D model, and displaying the portions of the target selected by the user on targeted areas according to calculated object portion specifications and object portion extensibility, so as to achieve the following effects: a user only needs to select the targeted areas and/or the portions of the target. The system 400 according to the 3D rendering method of the present invention can achieve displaying the portions in various parts of the goods realistically without modifying the model or creating a new model, resulting in simultaneously reducing user effort, reducing the burden on the system 400, and saving the time of users.

The foregoing descriptions of specific exemplary embodiments of the present invention have been presented for purposes of illustration and description. They are not intended to be exhaustive nor to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for object customization by high-speed and realistic 3D rendering through web pages, comprising:
generating a 3D model of an object with a three dimensional modeling tool, and outputting the generated 3D model to a 3D model file;
loading the 3D model file, preprocessing the 3D model file, and generating a binary snapshot file of the 3D model file;
triggering rendering of the 3D model by loading the binary snapshot file of the 3D model file, color-separated rendering, by a 3D rendering engine, of various parts of the 3D model of the object, and saving the data of the color-separated rendering in mask images;
calculating object portion specifications and object portion extensibility based on user selection and customization of one or more targeted portions of an image of the 3D model of the object;
displaying the one or more targeted portions of the 3D model based on the calculated object portion specifications and object portion extensibility; and
displaying the resulting images of the 3D model of the object after combining the calculated portions with the 3D model, without rerendering the 3D model.

2. The method according to claim 1, wherein generating the binary snapshot file comprises:
applying for a memory space with the same size as the 3D model file,
analyzing three dimensional data in the 3D model file and generating data in binary format that can be used for rendering directly by the 3D rendering engine;
recopying the data in binary format into the space successively according to a preset sequence; and
modifying offset distances of pointers accordingly.

3. The method according to claim 1, wherein the binary snapshot file is in the form of a binary stream compressed in LZO format.

4. The method according to claim 1, wherein the 3D model file is in OBJ format.

5. The method according to claim 4, wherein the data format used in the file of OBJ format is 16-bit unsigned integers.

6. The method according to claim 1, wherein the 3D rendering can be triggered through web pages.

7. The method according to claim 1, wherein the three dimensional modeling tool comprises 3DMAX or MAYA.

8. The method according to claim 1, wherein displaying the resulting images of the object after rendering or combining is performed through JavaScript technology.

9. The method according to claim 1, wherein the resulting images are pictures of the 3D model of the object from different angles.

10. The method according to claim 9, further comprising displaying several pictures of the object successively though rotation of a mouse wheel to achieve the perspective of three dimensional displaying of the object.
